(19) United States
(12) Patent Application Publication
(10) Pub. No.: US 2021/0155068 A1
(43) Pub. Date: May 27, 2021

(54) BUMP STOP ASSEMBLY

(71) Applicant: Continental Automotive Systems Inc., Auburn Hills, MI (US)

(72) Inventor: Ryan M. Stabel, Grand Blanc, MI (US)

(21) Appl. No.: 16/692,644

(22) Filed: Nov. 22, 2019

(51) Int. Cl. B60G 17/016; B60G 17/015; B60G 17/019; B60G 17/052

(52) U.S. Cl. CPC B60G 17/0164; B60G 17/0155; B60G 17/01908; B60G 17/0523; B60G 2202/242; B60G 2400/10; B60G 2400/412; B60G 2400/05; B60G 2400/50; B60G 2400/204

(57) ABSTRACT

An apparatus includes at least one pressurized air source, at least one switching valve is in fluid communication with the pressurized air source, and at least one bump stop assembly is in fluid communication with the at least one switching valve. The at least one bump stop assembly includes a body member that at least partially defines a pressure chamber that is in fluid communication with the at least one pressurized air source. A bump stop contact member is coupled to the pressure chamber. A controller is configured to vary a fluid pressure within the pressure chamber in response to an input from at least one vehicle sensor.

### TECHNICAL FIELD

The present disclosure relates to an improvement in vehicle control through the use of bump stops.

### BACKGROUND

Vehicles are being used on a wide range of terrains. For example, it is desirable to have a vehicle that is intended to be used off-road to also provide a comfortable ride when used on an improved road surfaces. Additionally, it is desirable to have a vehicle that can tow a large amount of weight and still provide a comfortable ride during towing and under other operating conditions. Therefore, there is a need to have a vehicle that can operate under a wide range of operating conditions and on various terrains.

### SUMMARY

In one exemplary embodiment, an apparatus includes at least one pressurized air source, at least one switching valve is in fluid communication with the pressurized air source, and at least one bump stop assembly is in fluid communication with the at least one switching valve. The at least one bump stop assembly includes a body member that at least partially defines a pressure chamber that is in fluid communication with the at least one pressurized air source. A bump stop contact member is coupled to the pressure chamber. A controller is configured to vary a fluid pressure within the pressure chamber in response to an input from at least one vehicle sensor.

In a further embodiment of any of the above, the at least one vehicle sensor includes at least one of a vehicle speed sensor or a vehicle acceleration sensor.

In a further embodiment of any of the above, the at least one vehicle sensor includes at least one of a vehicle suspension height sensor or a steering wheel angle sensor.

In a further embodiment of any of the above, the at least one pressurized air source includes a compressor.

In a further embodiment of any of the above, the at least one pressurized air source includes a pressure storage tank.

In a further embodiment of any of the above, the at least one switching valve directs pressurized air from the compressor to the pressure storage tank when in a first position.

In a further embodiment of any of the above, the at least one switching valve directs pressurized air from the pressure storage tank to the at least one bump stop assembly when in a second position.

In a further embodiment of any of the above, a pressure sensor is located in a fluid line between the at least one switching valve and the at least one bump stop.

In a further embodiment of any of the above, a bump stop valve is located in the fluid line between the at least one switching valve and the at least one bump stop.

In a further embodiment of any of the above, a bump stop shaft has a piston located in the pressure chamber at a first end. The contact member is located at a second end. At least a portion of the contact member includes a resilient impact material.

In another exemplary embodiment, a method comprising the steps of (a) determining at least one operating condition of a vehicle based on readings from at least one vehicle sensor and (b) varying a pressure in at least one bump stop assembly in response to the at least one operating condition of the vehicle.

In a further embodiment of any of the above, the at least one bump stop assembly includes a body member that at least partially defines a pressure chamber and is in fluid communication with at least one pressurized air source. A bump stop contact member is coupled to the pressure chamber.

In a further embodiment of any of the above, the at least one vehicle sensor includes at least one of a vehicle speed sensor, a vehicle acceleration sensor, a suspension travel sensor, or a steering wheel angle sensor.

In a further embodiment of any of the above, an internal pressure of the at least one bump stop assembly is increased above a predetermined level when the at least one vehicle sensor determines a variation in suspension travel above a threshold suspension travel variation level.

In a further embodiment of any of the above, the internal pressure of the at least one bump stop assembly is increased above a predetermined high pressure level when the at least one sensor determines a vehicle speed over a threshold speed level and suspension travel above a threshold suspension travel level.

In a further embodiment of any of the above, the internal pressure of the at least one bump stop assembly is increased above a predetermined high pressure level when the at least one sensor determines a vehicle acceleration over a threshold acceleration level and a suspension travel above a threshold suspension travel level.

In a further embodiment of any of the above, the internal pressure of the at least one bump stop assembly is increased above a predetermined high pressure level when the at least one sensor determines a vehicle speed over a threshold speed level and a steering wheel angle above a threshold steering wheel angle.

In a further embodiment of any of the above, the internal pressure of the at least one bump stop assembly is decreased below a predetermined low pressure level when the at least one sensor determines a vehicle speed below a threshold speed level and a steering wheel angle above a threshold steering wheel angle.

In a further embodiment of any of the above, the internal pressure of the at least one bump stop is decreased below a predetermined low pressure level when the at least one sensor determines a vehicle speed below a threshold speed level and a suspension travel above a threshold suspension travel level.

In a further embodiment of any of the above, the internal pressure of the at least one bump stop is decreased below a predetermined low pressure level when the at least one sensor determines a vehicle speed above a threshold speed level, a suspension travel below a threshold suspension travel level, and a steering wheel angle below a threshold steering wheel angle.

### BRIEF DESCRIPTION OF THE DRAWINGS

FIG. 1 illustrates a pair of bump stop assemblies located adjacent a vehicle suspension and fluidly connected to an air supply system.

FIG. 2 illustrates an example leaf spring suspension system.

FIG. 3 illustrates an example trailing arm suspension system.

FIG. 4 illustrates an example method of using the bump stop assemblies.

### DETAILED DESCRIPTION

During operation of a vehicle, the vehicle may encounter varying terrain and operating conditions. This is particularly true for vehicles that are designed for both on-road and off-road applications. When operating a vehicle on-road, the vehicle and suspension are less susceptible to sudden large impact forces. However, depending on the manner that the vehicle is operated off-road, the vehicle may be subject to large impact forces when used off-road. Additionally, the vehicles suspension may experience a large load when pulling a trailer either on-road or off-road. Through the use of bump stop assemblies, the vehicle's suspension can be tailored to exhibit favorable ride characteristics under both on-road and off-road use.

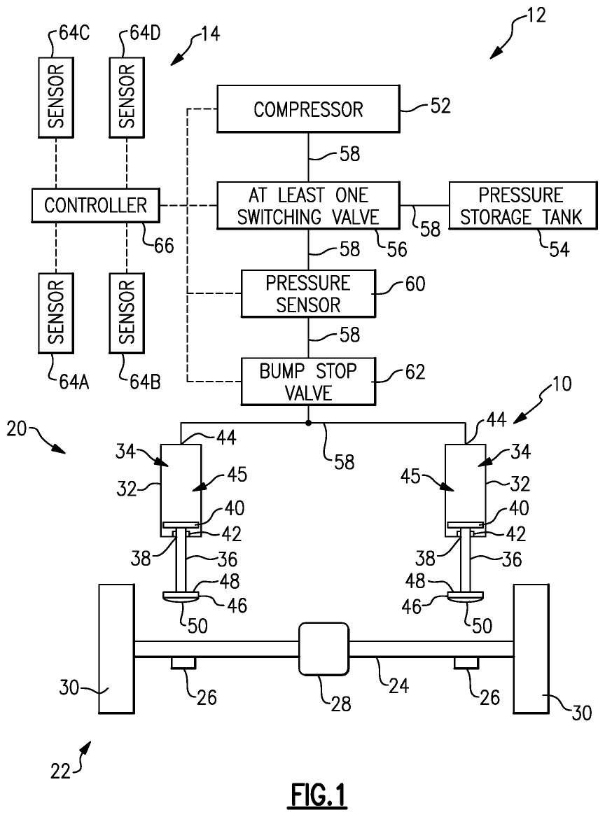

FIG. 1 schematically illustrates a pair of bump stop assemblies 10 located adjacent a vehicle suspension 22. The bump stop assemblies 10 are pneumatic and controlled by a control assembly 14 in electrical communication with an air supply system 12. The air supply system 12 is fluidly coupled to the bump stop assemblies 10 for varying a pressure within the bump stop assemblies 10. Varying the pressure within the bump stop assemblies 10 varies a spring rate provided to the vehicle suspension 22 to prevent damage to the vehicle suspension 22 that can occur when all of the vehicle's suspension travel is consumed. Additionally, varying the pressure within the bump stop assemblies 10 can level the vehicle's suspension 22 when carrying a heavy load.

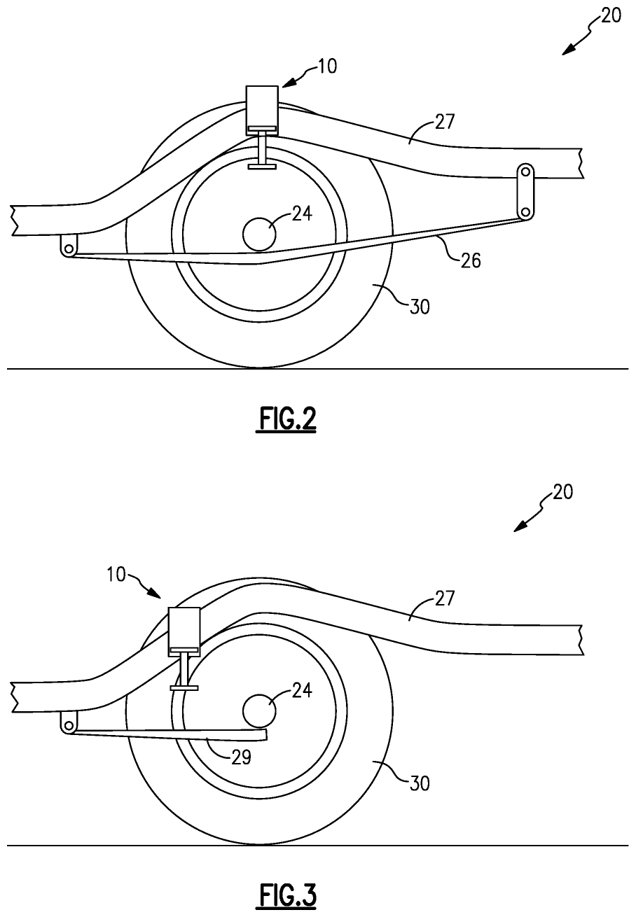

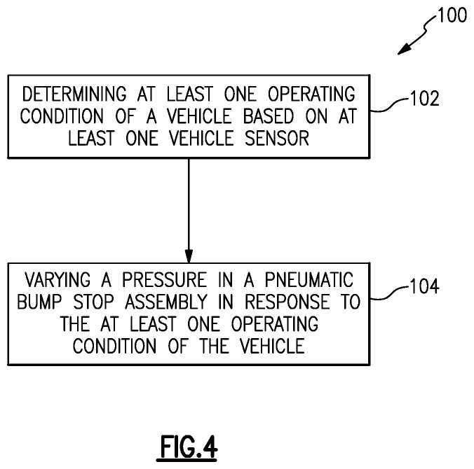

In the illustrated example, the vehicle suspension 22 includes an axle 24 at least partially supported by a pair of leaf springs 26 attached to a vehicle frame 27 with the bump stop assemblies 10 also fixed relative to the frame 27 (FIG. 2). Alternatively, the axle 24 could be connected to the frame 27 through a trailing arm 29 (FIG. 3). The axle 24 is driven by a differential 28 in communication with a vehicle drive train (not shown) and is rotatably connected to a pair of wheels 30. Although the axle 24 is illustrated as a rear axle, this disclosure would also apply to using the axle 24 in a front of a vehicle with or without a differential.

The bump stop assemblies 10 include a housing 32 at least partially defining an internal cavity 34. A bump stop shaft 36 extends through a shaft opening 38 in the housing 32 and is connected to a piston 40. A seal 42 creates a seal between the bump stop shaft 36 and the housing 32 to prevent debris from entering the housing 32. An air supply connection 44 is located at a proximal end of the housing 32 to allow air to be communicated into and out of a pressure chamber 45 at least partially defined by the housing 32 and the piston 40.

When air is communicated into and out of the pressure chamber 44, the air increases or decreases, respectively, the amount of force being applied to the piston 40. Therefore, the greater the pressure in the pressure chamber 45, the greater the force required to depress the piston 40. This results in the bump stop assembly 10 providing a greater spring rate to the vehicle's suspension 22. Conversely, the lower the pressure in the pressure chamber 45, the lower the force required to depress the piston 40 and the bump stop assembly 10 provides a reduced spring rate to the vehicle's suspension 22.

A distal end of the bump stop shaft 36 includes a contact member 46. In the illustrated example, the contact member 46 includes a disk shaped base member 48 connected to the bump stop shaft 36 and a resilient member 50 located on the disk shaped base member 48 opposite the bump stop shaft 36. The resilient member 50 is made an elastomeric or rubber material and is positioned to contact the axle 24 or another part of the vehicle's suspension 22, such as the trailing arm 29 as shown in FIG. 3. The resilient member 50 prevents metal to metal contact between the disk shaped base member 48 and the axle 24 which would increase the level of wear between the components. Additionally, even in a fully extended position, the distal end of the bump stop shaft 36 is spaced from the axle 24 when the vehicle is under a normal load, such as during on-road use.

In the illustrated example, the air supply system 12 includes a compressor 52 in fluid communication with a pressure storage tank 54 through the use of at least one switching valve 56 fluidly coupled to each other through air lines 58. When the at least one switching valve 56 is in a first position, pressurized air from the compressor 52 is directed into to the pressure storage tank 54. Conversely, when the at least one switching valve 56 is in a second position, pressurized air from the pressure storage tank 54 can be directed from the pressure storage tank 54 through the switching valves 56 and towards the bump stop assemblies 10. A pressure sensor 62 and a bump stop valve 64 are located fluidly between the switching valve 56 and the bump stop assemblies 10 to monitor and control a flow of air within the pressure chambers 45.

FIG. 4 illustrates a method of operating the bump stop assemblies 10. During operation of the vehicle 20 and the bump stop assemblies 10, the control assembly 14 determines an operating condition of the vehicle 20 by communicating with sensors 64 (Step 102) throughout the vehicle 20 to vary a pressure within the pressure chamber 45 of the bump stop assemblies 10 (Step 104). In the illustrated example, the control assembly 14 includes a controller 66 having a computer readable medium for storing programs to be executed by a microprocessor. The controller 66 is in electrical communication with the sensors 64, the compressor 52, the at least one switching valve 56, the pressure sensor 60, and the bump stop valve 62.

The sensors 64 can include at least one of a vehicle speed sensor 64A, a vehicle acceleration sensor 64B, a suspension travel sensor 64C, or a steering wheel angle sensor 64D. The vehicle speed sensor 64A could include a wheel speed sensor, the vehicle acceleration sensor 64B could include an accelerometer, the suspension travel sensor 64C could include rotary or linear potentiometers (as in commonly available ride height sensors), and the steering wheel angle sensor 64D could include a sensor in communication with a power steering system on the vehicle 20.

There are a number of combination of readings from the sensors 64A-64D that can indicate a likely preferred pressure level within the pressurize chamber 45 of the bump stop assemblies 10. For example, when a reading for the suspension travel sensor 64C is above a threshold suspension travel variation level, the controller 66 directs more pressurized air into the pressure chamber 45 in the bump stop assemblies 10. This provides an increased spring ratefor the suspension 22 when the suspension 22 is experiencing large variations in travel that could indicate rough terrain or large impacts. Similarly, the controller 66 could direct more air into the bump stop assemblies 10 if a reading from the speed sensor 64A is above a threshold speed level or if a reading from the acceleration sensor 64B is above a predetermined threshold acceleration level,

Additionally, the controller 66 could direct more air into the bump stop assemblies 10 if the vehicle speed was above a predetermined threshold and the steering wheel angle measured by the steering angle sensor 64 was above a predetermined steering wheel angle.

However, there are also situations when the suspension 22 might be encountering large suspension travel variations above a predetermined threshold, but the pressurized air in the pressure chamber 45 should be at a low pressure level to reduce the spring rate provided by the bump stop assemblies 10. One indicator that the spring rate provided by the bump stop assemblies 10 should be low, even though the variations in suspension travel exceed a predetermined level, is when the vehicle 20 also has a slow speed measured by the vehicle speed sensor 64A. This situation could indicate that the vehicle 20 is encountering large obstacles and needs increased suspension travel with reduced spring rate from the bump stop assemblies 10.

Additionally, a steering wheel angle above a predetermined threshold in combination with the low speed and the large variation in suspension travel could indicated a reduction in spring rate and pressure within the pressure chamber 45.

Furthermore, there may be situations where the vehicle speed exceeds the predetermined speed threshold, but the controller 66 reduces a pressure level within the pressure chamber 45 or maintains the pressure level at a low level. Situations where this may apply includes situations where the vehicle 20 is driving at high speed on a smooth road surface. The controller 66 may determine the vehicle 20 is on a smooth road surface if the vehicle suspension travel variation is below the predetermined threshold and the steering wheel angle variation is below the predetermined steering wheel threshold angle.

When it is desired to have a low pressure in the pressure chambers 45, the pressure level could be between 10 and 50 psi and when it is desired to have a high pressure in the pressure chamber 45, the pressure level could be 500+ psi. Additionally, a vehicle suspension travel percentage of 50% could provide a predetermined threshold between high and low suspension travel.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present disclosure.

Although the different examples have specific components shown in the illustrations, embodiments of this disclosure are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. An apparatus comprising:
at least one pressurized air source;
at least one switching valve in fluid communication with the pressurized air source;
at least one bump stop assembly in fluid communication with the at least one switching valve, the at least one bump stop assembly including:
a body member at least partially defining a pressure chamber in fluid communication with the at least one pressurized air source; and
a bump stop contact member coupled to the pressure chamber; and
a controller configured to vary a fluid pressure within the pressure chamber in response to an input from at least one vehicle sensor.

2. The apparatus according to claim 1, wherein the at least one vehicle sensor includes at least one of a vehicle speed sensor or a vehicle acceleration sensor.

3. The apparatus according to claim 1, wherein the at least one vehicle sensor includes at least one of a vehicle suspension height sensor or a steering wheel angle sensor.

4. The apparatus according to claim 1, wherein the at least one pressurized air source includes a compressor.

5. The apparatus according to claim 4, wherein the at least one pressurized air source includes a pressure storage tank.

6. The apparatus according to claim 5, wherein the at least one switching valve directs pressurized air from the compressor to the pressure storage tank when in a first position.

7. The apparatus according to claim 5, wherein the at least one switching valve directs pressurized air from the pressure storage tank to the at least one bump stop assembly when in a second position.

8. The apparatus according to claim 1, including a pressure sensor located in a fluid line between the at least one switching valve and the at least one bump stop.

9. The apparatus according to claim 8, including a bump stop valve located in the fluid line between the at least one switching valve and the at least one bump stop.

10. The apparatus according to claim 1, including a bump stop shaft having a piston located in the pressure chamber at a first end and the contact member located at a second end and at least a portion of the contact member includes a resilient impact material.

11. A method comprising the steps of:
(a) determining at least one operating condition of a vehicle based on readings from at least one vehicle sensor; and
(b) varying a pressure in at least one bump stop assembly in response to the at least one operating condition of the vehicle.

12. The method according to claim 11, wherein the at least one bump stop assembly includes:
a body member at least partially defining a pressure chamber and in fluid communication with at least one pressurized air source; and
a bump stop contact member coupled to the pressure chamber.

13. The method according to claim 11, wherein the at least one vehicle sensor includes at least one of a vehicle speed sensor, a vehicle acceleration sensor, a suspension travel sensor, or a steering wheel angle sensor.

14. The method according to claim 13, wherein an internal pressure of the at least one bump stop assembly is increased above a predetermined level when the at least one vehicle sensor determines a variation in suspension travel above a threshold suspension travel variation level.

15. The method according to claim 13, wherein the internal pressure of the at least one bump stop assembly is increased above a predetermined high pressure level when the at least one sensor determines a vehicle speed over a threshold speed level and suspension travel above a threshold suspension travel level.

16. The method according to claim 13, wherein the internal pressure of the at least one bump stop assembly is increased above a predetermined high pressure level when the at least one sensor determines a vehicle acceleration over a threshold acceleration level and a suspension travel above a threshold suspension travel level.

17. The method according to claim 13, wherein the internal pressure of the at least one bump stop assembly is increased above a predetermined high pressure level when the at least one sensor determines a vehicle speed over a threshold speed level and a steering wheel angle above a threshold steering wheel angle.

18. The method according to claim 13, wherein the internal pressure of the at least one bump stop assembly is decreased below a predetermined low pressure level when the at least one sensor determines a vehicle speed below a threshold speed level and a steering wheel angle above a threshold steering wheel angle.

19. The method according to claim 13, wherein the internal pressure of the at least one bump stop is decreased below a predetermined low pressure level when the at least one sensor determines a vehicle speed below a threshold speed level and a suspension travel above a threshold suspension travel level.

20. The method according to claim 13, wherein the internal pressure of the at least one bump stop is decreased below a predetermined low pressure level when the at least one sensor determines a vehicle speed above a threshold speed level, a suspension travel below a threshold suspension travel level, and a steering wheel angle below a threshold steering wheel angle.
